(19) United States
(12) Patent Application Publication
(10) Pub. No.: US 2015/0239754 A1
(43) Pub. Date: Aug. 27, 2015

(54) Treatment System and Treatment Method

(71) Applicant: Kabushiki Kaisha Toshiba, Tokyo (JP)

(72) Inventors: Arisa YAMADA, Kawasaki (JP); Kenji SANO, Tokyo (JP); Toshihiro IMADA, Kawasaki (JP)

(73) Assignee: Kabushiki Kaisha Toshiba

(21) Appl. No.: 14/631,238

(22) Filed: Feb. 25, 2015

(30) Foreign Application Priority Data
Feb. 26, 2014 (JP) 2014-035807

(51) Int. Cl. C02F 1/44

(52) U.S. Cl. CPC C02F 1/445; C02F 2103/08

(57) ABSTRACT

A treatment system of the embodiment includes an osmotic pressure treatment unit having: a first tank which holds a treatment target solution, a second tank which holds a draw solution containing an osmotic pressure inducer and a solvent, and a semipermeable membrane which is interposed between the first tank and the second tank. The osmotic pressure inducer is prepared by chemically modifying a support with a polymer having an upper critical solution temperature or a lower critical solution temperature.

### CROSS-REFERENCE TO RELATED APPLICATION

This application is based upon and claims the benefit of priority from Japanese Patent Application No. 2014-035807, filed Feb. 26, 2014, the entire contents of which are incorporated herein by reference.

### FIELD

Embodiments of the present invention relate to a treatment system and a treatment method.

### BACKGROUND

A method called the forward osmosis membrane seawater desalination method (FO method) is a known method of desalinating seawater. In the FO method, ammonium carbonate water having a higher concentration than that of seawater is disposed on the transmission side of a semipermeable membrane. With such a structure, the water within the seawater can be drawn through the permeable membrane from the supply side to the transmission side under the osmotic pressure of the ammonium carbonate, without applying pressure to the semipermeable membrane. The ammonium carbonate solution containing the water that has passed through the semipermeable membrane is then heated to about 60° C. As a result, the ammonium carbonate is removed from the ammonium carbonate solution containing the water, and water is obtained.

However, in the FO method, the treatment efficiency is inadequate, making it unprofitable. Further, in the FO method that uses ammonium carbonate, achieving complete removal of the ammonium carbonate from the ammonium carbonate solution containing the water that has been extracted from seawater is difficult. Consequently, practical application of the FO method is not currently possible.

Further, methods have also been proposed in which a temperature-responsive polymer is used to control the osmotic pressure, thereby drawing the water within seawater through the permeable membrane from the supply side to the transmission side and extracting the water.

However, in methods using conventional temperature-responsive polymers, separating the temperature-responsive polymer from the solution containing the water that has passed through the semipermeable membrane and the temperature-responsive polymer has proven difficult. As a result, some temperature-responsive polymer has often remained in the water following the separation.

### BRIEF DESCRIPTION OF DRAWINGS

FIG. 1A is a schematic block diagram illustrating a treatment system of a first embodiment.

FIG. 1B is a schematic block diagram illustrating a modification of the treatment system of the first embodiment.

FIG. 2A is an explanatory diagram for describing one example of a method of producing an osmotic pressure inducer.

FIG. 2B is an explanatory diagram for describing one example of a method of producing an osmotic pressure inducer.

FIG. 3 is a schematic block diagram illustrating a treatment system of a second embodiment.

FIG. 4 is an explanatory diagram for describing samples prepared in the examples.

FIG. 5 is an explanatory diagram for describing samples prepared in the examples.

### DESCRIPTION OF EMBODIMENTS

A treatment system of the embodiment includes an osmotic pressure treatment unit having: a first tank which holds a treatment target solution, a second tank which holds a draw solution, and a semipermeable membrane which is interposed between the first tank and the second tank. The draw solution contains an osmotic pressure inducer, prepared by chemically modifying a support with a polymer having an upper critical solution temperature or a lower critical solution temperature, and a solvent.

Embodiments of the treatment system and the treatment method are described below with reference to the drawings. Common components across the embodiments are labeled using the same reference signs, and duplicate descriptions of these components are omitted. Further, each drawing is merely a schematic diagram used for describing each embodiment, and the shapes and dimensional ratios and the like illustrated in each diagram may differ from the actual shapes and dimensions, and appropriate design modifications may be made with due consideration of the following description and the conventional technology.

### First Embodiment

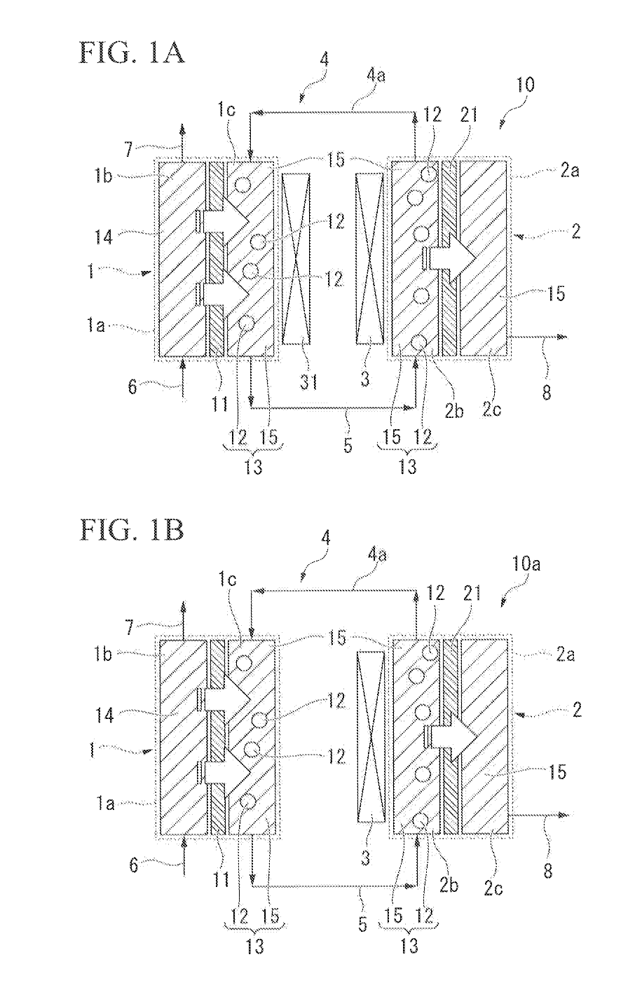

FIG. 1A is a schematic block diagram illustrating a treatment system of a first embodiment. The treatment system 10 is a system which desalinates a salt water which represents a treatment target solution 14, and extracts the water which represents the solvent incorporated within the salt water. As illustrated in FIG. 1A, the treatment system 10 of the first embodiment has an osmotic pressure treatment unit 1, a separation unit 2, a heating unit (temperature control unit) 3, and a cooling unit (temperature control unit) 31.

The treatment system 10 illustrated in FIG. 1A has a supply unit 6 which supplies the salt water that represents the treatment target solution 14 to the osmotic pressure treatment unit 1, a discharge unit 7 which discharges, from the osmotic pressure treatment unit 1, a concentrate obtained upon removal of the water that represents the solvent 15 from the treatment target solution 14, a pipe 5 which supplies a draw solution 13 from the osmotic pressure treatment unit 1 to the separation unit 2, a treated liquid discharge unit 8 which discharges the water (treated water) that represents the solvent separated in the separation unit 2, and a pipe 4a (recycling unit 4) which supplies an osmotic pressure inducer 12 from a supply tank 2b of the separation unit 2 to a transmission tank 1c of the osmotic pressure treatment unit 1.

The treatment system 10 of the present embodiment may include a pump (not shown in the drawing) for supplying the draw solution 13 from the osmotic pressure treatment unit 1 to the separation unit 2, and may include a pump (not shown in the drawing) for supplying the osmotic pressure inducer 12 from the separation unit 2 to the draw solution 13 in the osmotic pressure treatment unit 1.

The osmotic pressure treatment unit 1 has a treatment tank 1a, and a semipermeable membrane 11 which separates the interior of the treatment tank 1a into a supply tank (first tank) 1b and a transmission tank (second tank) 1c. The supply tank 1b holds the treatment target solution 14. The transmission tank 1c holds the draw solution 13.

The semipermeable membrane 11 is interposed between the supply tank 1b and the transmission tank 1c. The semipermeable membrane 11 has permeability relative to the solvent incorporated within the treatment target solution 14, but is impermeable relative to the removal target substance contained within the treatment target solution 14. In the present embodiment, a membrane which has permeability relative to the water within the salt water that represents the treatment target solution 14, but is impermeable relative to the salt is used as the semipermeable membrane 11.

A mechanical stirring device and/or a non-contact magnetic stirring device may be installed inside the treatment tank 1a according to need.

The osmotic pressure treatment unit 1 causes the solvent within the treatment target solution 14 to pass through the semipermeable membrane 11 as a result of the osmotic pressure difference between the salt water of the treatment target solution 14 and the draw solution 13, thereby moving the solvent into the draw solution 13. As illustrated in FIG. 1A, the draw solution 13 contains the osmotic pressure inducer 12 and the water that represents the solvent 15 of the salt water.

The osmotic pressure inducer 12 is prepared by chemically modifying a support with a polymer having a lower critical solution temperature (a temperature-responsive polymer). In the present embodiment, the temperature-responsive polymer incorporated in the osmotic pressure inducer 12 within the draw solution 13 of the osmotic pressure treatment unit 1 is hydrated by the water within the draw solution 13 and exists in a liquid state (In FIG. 1A, in order to facilitate comprehension of the fact that the osmotic pressure inducer 12 exists within the draw solution 13, the osmotic pressure inducer 12 is indicated by circles). As a result, the osmotic pressure of the draw solution 13 of the osmotic pressure treatment unit 1 is higher than that of the treatment target solution 14.

The separation unit 2 has a treatment tank 2a, and a separation membrane 21 which separates the interior of the treatment tank 2a into a supply tank (third tank) 2b and a transmission tank (fourth tank) 2c. The supply tank 2b holds the draw solution 13 containing the osmotic pressure inducer 12. The transmission tank 2c holds the solvent 15 separated from the draw solution 13.

The separation unit 2 uses the separation membrane 21 to separate the solvent 15 within the draw solution 13 from the draw solution 13 that is supplied to the supply tank 2b of the treatment tank 2a from the osmotic pressure treatment unit 1. In the present embodiment, the temperature-responsive polymer incorporated in the osmotic pressure inducer 12 within the draw solution 13 of the separation unit 2 exists as a solid. Accordingly, in the separation unit 2 illustrated in FIG. 1A, within the draw solution 13 containing the osmotic pressure inducer 12 which has undergone a phase change to become solid, only the solvent 15 passes through the separation membrane 21 and is supplied to the transmission tank 2c, thereby separating the water that represents the solvent 15 from the draw solution 13.

The separation membrane 21 is interposed between the supply tank 2b and the transmission tank 2c. The separation membrane 21 has pores that are smaller than the size of the osmotic pressure inducer 12 that has undergone a phase change to become solid, and is therefore impermeable relative to the osmotic pressure inducer 12 that has undergone a phase change to become solid. There are no particular limitations on the material of the separation membrane 21, and examples of the material include metals, glass, filter cloths, ceramics and polymers.

The heating unit (temperature control unit) 3 is disposed on the outside surface of the supply tank 2b in the treatment tank 2a of the separation unit 2, as illustrated in FIG. 1A. The heating unit 3 heats the osmotic pressure inducer 12 within the draw solution 13 supplied from the osmotic pressure treatment unit 1 to the separation unit 2, either directly or indirectly.

In the present embodiment, even if the osmotic pressure inducer 12 supplied to the draw solution 13 of the separation unit 2 via the pipe 5 has a temperature less than the lower critical solution temperature, the heating unit 3 is used to heat the osmotic pressure inducer 12 to a temperature equal to or greater than the lower critical solution temperature. As a result, the temperature-responsive polymer incorporated in the osmotic pressure inducer 12 undergoes a phase change and becomes solid.

Any device may be used as the heating unit 3, provided it is capable of heating the osmotic pressure inducer 12 to a temperature equal to or greater than the lower critical solution temperature, and for example a heater or heat pump or the like can be used. A boiler or the like may be used as the heat source for the heating unit 3, or waste heat or the like from a factory may be used. Further, when the support incorporated within the osmotic pressure inducer 12 is a magnetic body, it is preferable that a device which applies an alternating magnetic field to the support is used as the heating unit 3.

The cooling unit (temperature control unit) 31 is disposed on the outside surface of the transmission tank 1c in the treatment tank 1a of the osmotic pressure treatment unit 1, as illustrated in FIG. 1A. The cooling unit 31 cools the osmotic pressure inducer 12 within the draw solution 13 in the osmotic pressure treatment unit 1, either directly or indirectly.

In the present embodiment, the ambient environmental temperature in which the treatment system 10 is installed is less than the lower critical solution temperature of the temperature-responsive polymer incorporated in the osmotic pressure inducer 12. As a result, at the point when treatment of the treatment target solution 14 using the treatment system 10 is started, the temperature-responsive polymer incorporated in the osmotic pressure inducer 12 has undergone a phase change to a liquid state. Further, even if the osmotic pressure inducer 12 supplied to the transmission tank 1c of the osmotic pressure treatment unit 1 via the pipe 4a of the recycling unit 4 has a temperature equal to or greater than the lower critical solution temperature, the temperature is cooled to a temperature less than the lower critical solution temperature by the cooling unit 31. As a result, the temperature-responsive polymer incorporated in the osmotic pressure inducer 12 inside the transmission tank 1c undergoes a phase change to a liquid state.

Any device may be used as the cooling unit 31, provided it is capable of cooling the osmotic pressure inducer 12 to a temperature less than the lower critical solution temperature, and for example a chiller or the like can be used.

The recycling unit 4 supplies the osmotic pressure inducer 12, which has been separated from the draw solution 13 by the separation unit 2, from the supply tank 2b of the treatment tank 2a to the draw solution 13 of the osmotic pressure treatment unit 1. As illustrated in FIG. 1A, the recycling unit 4 has a pipe 4a that connects the supply tank 2b of the separation unit 2 and the transmission tank 1c of the osmotic pressure treatment unit 1.

Because the treatment system 10 of the present embodiment has the recycling unit 4, the osmotic pressure inducer 12 can be reused.

Next is a detailed description of the osmotic pressure inducer 12 used in the present embodiment.

The osmotic pressure inducer 12 is prepared by chemically modifying a support with a temperature-responsive polymer having a lower critical solution temperature.

Examples of materials that can be used as the support include materials which do not dissolve in the solvent within the draw solution 13, and can be chemically modified by the temperature-responsive polymer having a lower critical solution temperature.

The support is preferably a magnetic body. The magnetic body used for forming the support is preferably composed of particles containing one or more of iron, cobalt and nickel, which exhibit good heating efficiency by hysteresis loss.

It is desirable that the magnetic body which forms the support is a substance which exhibits ferromagnetism in the room temperature region. Examples of this type of magnetic body include iron and alloys containing iron. Specific examples include magnetite, ilmenite, pyrrhotite, magnesia ferrite, cobalt ferrite, nickel ferrite and barium ferrite. When the treatment target solution 14 is salt water, then among the materials for the support, the use of ferrite-based compounds, which exhibit excellent stability in water, is preferable. For example, the magnetic iron ore magnetite (Fe₃O₄) is not only inexpensive, but also exhibits good stability as a magnetic body within water and is stable as an element, making it ideal as the support when the treatment target solution 14 is salt water.

Particles composed of a metal oxide or a metalloid oxide selected from among silica, titania, alumina and zirconia may also be used as the support.

Further, particles composed of an organic material such as a polyethylene resin, polypropylene resin, polystyrene resin, polyvinyl chloride resin, polyethylene terephthalate resin, phenolic resin, urea resin, melamine resin, epoxy resin, silicone resin, polyurethane resin or acrylic resin may also be used as the support.

The support may also be composed of base particles and a coating layer which coats the base particles. The support materials mentioned above can be used as the base particles. Examples of the coating layer include iron and alloys containing iron. Specifically, particles obtained by forming a coating layer composed of magnetite around the periphery of base particles composed of silica can be used. Further, the coating layer may also be formed by performing a plating treatment such as Cu plating or Ni plating on the base particles.

There are no particular limitations on the shape of the support, and various shapes such as spherical, polyhedral or amorphous shapes can be used. The shape of the support is preferably spherical or polyhedral having rounded corners.

Although not particularly limited, the average particle size of the support is preferably from 0.1 to 5,000 μm, and more preferably from 10 to 500 μm. Provided the average particle size of the support is at least as large as the lower limit, the support 12a has satisfactory size. As a result, when, for example, a magnetic body is used as the support, the osmotic pressure inducer 12 can be easily recovered from the draw solution 13 containing the osmotic pressure inducer 12 by using magnetism. Further, provided the average particle size of the support is not more than the upper limit, the support is satisfactorily small. As a result, the specific surface area of the support is satisfactorily large, and the amount of chemical modification of the temperature-responsive polymer can be ensured. Accordingly, the function of the osmotic pressure inducer 12 in increasing the osmotic pressure of the draw solution 13 of the osmotic pressure treatment unit 1 can be obtained satisfactorily.

The average particle size of the support can be measured, for example, by a sieving method. Specifically, the average particle size can be measured in accordance with JIS Z8901:2006 “Test Powders and Test Particles”, by performing sieving using a plurality of sieves having mesh sizes within a range from 10 μm to 500 μm.

In the present embodiment, a temperature-responsive polymer having a lower critical solution temperature (LCST) is used as the temperature-responsive polymer for chemically modifying the support.

Specifically, for the polymers that can be used as the temperature-responsive polymer having a lower critical solution temperature (LCST), it is possible to use N-substituted (meth)acrylamide derivatives such as N-n-propyl acrylamide, N-isopropyl acrylamide, N-t-butyl acrylamide, N-ethyl acrylamide, N,N-dimethyl acrylamide, N-acryloyl pyrrolidine, N-acryloyl piperidine, N-acryloyl morpholine, N-n-propyl methacrylamide, N-isopropyl methacrylamide. N-ethyl methacrylamide, N,N-dimethyl methacrylamide, N-methacryloyl pyrrolidine, N-methacryloyl piperidine, and N-methacryloyl morpholine. Further, polyoxyethylene alkylamine derivatives, polyoxyethylene sorbitan ester derivatives, polyoxyethylene alkyl phenyl ether (meth)acrylates, and polyoxyethylene (meth)acrylate ester derivatives and the like may also be used as the temperature-responsive polymer. The temperature-responsive polymer having a lower critical solution temperature (LCST) may be either a homopolymer or a copolymer.

The lower critical solution temperature of the temperature-responsive polymer is preferably at least 10° C. but not more than 50° C. It is preferable that the lower critical solution temperature satisfies the range, because it means that when the treatment system 10 of the present embodiment is installed and used under a room temperature environmental temperature of about 25° C., the energy required for the heating and/or cooling used to achieve phase change of the temperature-responsive polymer can be reduced. Furthermore, when the lower critical solution temperature satisfies the range, waste heat or the like from a factory or the like can be more easily used as the heat source for the heating unit 3, which is also desirable.

The osmotic pressure inducer 12 can be produced, for example, using the method described below.

For example, when the support is composed of an organic material, the osmotic pressure inducer 12 can be produced by irradiating the support with an electron beam or the like to generate radicals, and then performing graft polymerization of a monomer for the temperature-responsive polymer using the radicals as starting points.

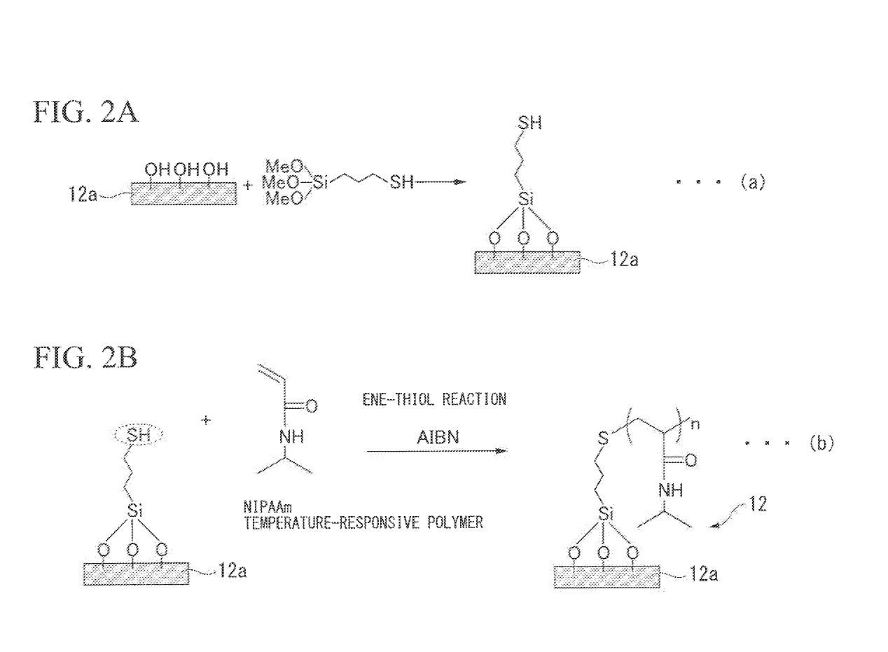

Next is a description, using the drawings, of a method of producing the osmotic pressure inducer 12 when the support is composed of an inorganic material. FIG. 2A and FIG. 2B are explanatory diagrams describing one example of a method of producing the osmotic pressure inducer 12.

First, as illustrated by formula (a) in FIG. 2A, the surface of the support 12a is modified by a silane coupling agent. Subsequently, as illustrated in formula (b) in FIG. 2B, the temperature-responsive polymer is polymerized by a radical reaction using a radical initiator, with a tifunctional group of the silane coupling agent acting as a starting point. This enables the production of the osmotic pressure inducer 12. FIG. 2B illustrates, as one example, the case in which azobisisobutyronitrile (AIBN) is used as the radical initiator, and N-isopropyl acrylamide (NIPAAm) is used for the temperature-responsive polymer. The radical reaction used when chemically modifying the support with the temperature-responsive polymer can be performed, for example, by a method in which the monomer for the temperature-responsive polymer and the support that has been modified by the silane coupling agent are placed in a solvent, the radical initiator is then added, and a reaction is performed at a temperature of 50° C. to 150° C.

Compounds having a vinyl group, thiol group, amino group, or halogen atom or the like can be used as the silane coupling agent. A specific example of the silane coupling agent is 3-mercaptopropyltrimethoxysilane.

A peroxide catalyst and/or an azo catalyst can be used as the radical initiator. Examples of the peroxide catalyst include benzoyl peroxide, lauroyl peroxide and tert-butyl hydroxyl peroxide. An example of the azo catalyst is azobisisobutyronitrile (AIBN).

In the osmotic pressure inducer 12, it is preferable that the amount of chemical modification of the support by the temperature-responsive polymer having a lower critical solution temperature is large. When the amount of modification by the temperature-responsive polymer is large, the function of the osmotic pressure inducer 12 in increasing the osmotic pressure of the draw solution 13 of the osmotic pressure treatment unit 1 is enhanced.

Further, in the osmotic pressure inducer 12, it is preferable that the temperature-responsive polymer having a lower critical solution temperature which chemically modifies the support has a large molecular weight. The larger the molecular weight of the temperature-responsive polymer, the more the function of the osmotic pressure inducer 12 in increasing the osmotic pressure of the draw solution 13 of the osmotic pressure treatment unit 1 is enhanced. Specifically, in the osmotic pressure inducer 12, the average molecular weight of the temperature-responsive polymer which chemically modifies the support is preferably 1,000 or greater.

There are no particular limitations on the amount of the osmotic pressure inducer 12 added to the draw solution 13, and the amount may be adjusted as appropriate so as to make the osmotic pressure of the draw solution 13 higher than that of the treatment target solution 14.

Next, a treatment method for treating the treatment target solution using the treatment system 10 of the first embodiment illustrated in FIG. 1A is described.

First, the osmotic pressure inducer 12 is supplied to the transmission tank 1c inside the treatment tank 1a. The water that represents the solvent 15 for the treatment target solution 14 may also be supplied to the transmission tank 1c inside the treatment tank 1a in order to wet the contact region between the osmotic pressure inducer 12 and the semipermeable membrane 11 in advance, prior to the start of the treatment using the treatment system 10. The temperature of the osmotic pressure inducer 12 supplied to the transmission tank 1c of the osmotic pressure treatment unit 1 is the ambient environmental temperature of the treatment system 10, and is a temperature less than the lower critical solution temperature. Accordingly, the osmotic pressure inducer 12 exists in a dissolved state in which the temperature-responsive polymer incorporated in the osmotic pressure inducer 12 is hydrated by the solvent. As a result, the function of the osmotic pressure inducer 12 in increasing the osmotic pressure of the draw solution 13 can be obtained.

Subsequently, as illustrated in FIG. 1A, the salt water that represents the treatment target solution 14 is supplied to the supply tank 1b inside the treatment tank 1a of the osmotic pressure treatment unit 1.

In the treatment system 10, when the treatment target solution 14 is supplied to the supply tank 1b inside the treatment tank 1a, a difference in osmotic pressure develops between the treatment target solution 14 and the draw solution 13 held in the transmission tank 1c of the treatment tank 1a. This difference in osmotic pressure becomes the driving force that causes the water that represents the solvent within the treatment target solution 14 to pass through the semipermeable membrane 11, and so the water within the treatment target solution 14 passes through the semipermeable membrane 11 and moves into the draw solution 13 in the transmission tank 1c (transmission treatment step). The solvent 15 that has passed through the semipermeable membrane 11 in this manner is desalinated by the semipermeable membrane 11.

As illustrated in FIG. 1A, the concentrate of the treatment target solution 14, which is generated upon extraction of the water 15 that represents the solvent from the treatment target solution 14, is discharged from the osmotic pressure treatment unit 1 via the discharge unit 7.

Next, as illustrated in FIG. 1A, the draw solution 13 is supplied from the transmission tank 1c of the treatment tank 1a of the osmotic pressure treatment unit 1 to the separation unit 2 via the pipe 5. The draw solution 13 that has been transferred to the separation unit 2 is heated by the heating unit 3 so that the osmotic pressure inducer 12 within the draw solution 13 reaches a temperature equal to or greater than the lower critical solution temperature. As a result, the temperature-responsive polymer incorporated in the osmotic pressure inducer 12 undergoes a phase change to become solid. When the osmotic pressure inducer 12 reaches a temperature equal to or greater than the lower critical solution temperature, the hydrated water molecules detach from the polymer chain of the temperature-responsive polymer, and therefore the osmotic pressure-inducing force is lost.

In the present embodiment, when the support incorporated in the osmotic pressure inducer 12 is a magnetic body, and a device which applies an alternating magnetic field to the support is used as the heating unit 3, hysteresis loss is generated by applying an alternating magnetic field to the support, thereby heating the magnetic body used as the support. As a result, the macromolecules of the temperature-responsive polymer which chemically modify the support can be heated efficiently without requiring any contact with the osmotic pressure inducer 12. For example, when the heating unit 3 is a heater, in order to raise the temperature of the osmotic pressure inducer 12 within the draw solution 13 held in the supply tank 2b inside the treatment tank 2a of the separation unit 2 to a temperature equal to or greater than the lower critical solution temperature, it is necessary to heat all of the draw solution 13 held in the supply tank 2b. Accordingly, when the macromolecules of the temperature-responsive polymer which chemically modify the support are heated by a method in which an alternating magnetic field is applied to the support, the energy required to achieve a phase change of the temperature-responsive polymer is less than that required when the heating unit 3 is a heater.

In the present embodiment, as illustrated in FIG. 1A, the separation membrane 21 of the separation unit 2 is used to separate the solvent 15 within the draw solution 13 from the draw solution 13 containing the osmotic pressure inducer 12 that has undergone a phase change to become solid. Then, the water (treated water) that represents the solvent 15 separated by the separation unit 2 is discharged via the treated liquid discharge unit 8.

In the present embodiment, the osmotic pressure inducer 12 that has undergone a phase change to become solid and has been separated in the separation unit 2 is supplied from the separation unit 2 to the draw solution 13 of the osmotic pressure treatment unit 1 via the pipe 4a (the recycling unit 4), and is reused.

In the present embodiment, the osmotic pressure inducer 12 that has been transferred into the draw solution 13 of the osmotic pressure treatment unit 1 is cooled by the cooling unit 31 to a temperature less than the lower critical solution temperature. As a result, the temperature-responsive polymer incorporated in the osmotic pressure inducer 12 undergoes a phase change and becomes liquid.

The treatment system 10 of the present embodiment contains the osmotic pressure treatment unit 1 having the supply tank 1b which holds the treatment target solution 14, the transmission tank 1c which holds the draw solution 13, and the semipermeable membrane 11 which is interposed between the supply tank 1b and the transmission tank 1c, wherein the draw solution 13 contains the osmotic pressure inducer 12 prepared by chemically modifying the support with the temperature-responsive polymer having a lower critical solution temperature, and the solvent 15. As a result, the solvent 15 within the treatment target solution 14 passes through the semipermeable membrane 11 and moves into the draw solution 13 due to the difference in osmotic pressure between the treatment target solution 14 and the draw solution 13. Accordingly, in the treatment system 10 of the present embodiment, no energy is required to cause the treatment target solution 14 to permeate through the semipermeable membrane 11, and the energy required for treating the treatment target solution 14 can be reduced.

Furthermore, in the treatment system 10 of the present embodiment, the draw solution 13 contains the osmotic pressure inducer 12 prepared by chemically modifying the support with the temperature-responsive polymer having a lower critical solution temperature, and the solvent 15. By heating the osmotic pressure inducer 12 prepared by chemically modifying the support with the temperature-responsive polymer having a lower critical solution temperature to a temperature equal to or greater than the lower critical solution temperature, the temperature-responsive polymer incorporated in the osmotic pressure inducer 12 undergoes a phase change and becomes solid. The solid osmotic pressure inducer 12 has extremely low solubility and exhibits excellent shape stability, and therefore the filtration rate is fast and the handling properties are favorable. Accordingly, the solid osmotic pressure inducer 12 can be readily separated from the draw solution 13 with good precision.

As a result, compared with the case where, for example, only a temperature-responsive polymer having a lower critical solution temperature is used instead of the osmotic pressure inducer 12, impurities incorporated as a result of treating the treatment target solution 14 are less likely to be retained in the treated liquid (the treated water), meaning a high-purity treated water can be obtained. Further, the recyclable osmotic pressure inducer 12 can be recovered at a high recovery rate.

Examples of modifications of the treatment system 10 illustrated in FIG. 1A are described below.

For example, when the support incorporated in the osmotic pressure inducer 12 in the present embodiment is a magnetic body, the osmotic pressure inducer 12 may be recovered from the draw solution 13 containing the osmotic pressure inducer 12 using magnetism. This method also enables the solvent 15 within the draw solution 13 to be separated from the draw solution 13 containing the osmotic pressure inducer 12. In this case, the draw solution 13 containing the osmotic pressure inducer 12 need not be passed through the separation membrane 21 of the separation unit 2. Accordingly, the separation membrane 21 can be omitted.

In the treatment system 10 illustrated in FIG. 1A, the heating unit 3 is provided on the outside surface of the supply tank 2b in the treatment tank 2a of the separation unit 2, but the heating unit 3 may also be provided on the pipe 5 which supplies the draw solution 13 from the osmotic pressure treatment unit 1 to the separation unit 2.

In the treatment system 10 illustrated in FIG. 1A, the cooling unit 31 is provided on the outside surface of the transmission tank 1c in the treatment tank 1a of the osmotic pressure treatment unit 1, but the cooling unit 31 may also be provided on the pipe 4a (the recycling unit 4) which supplies the osmotic pressure inducer 12 from the separation unit 2 to the draw solution 13 in the osmotic pressure treatment unit 1.

In the treatment system 10 illustrated in FIG. 1A, the cooling unit 31 is provided, but as illustrated in a treatment system shown 10a in FIG. 1B, the cooling unit 31 illustrated in FIG. 1A need not be provided. In other words, the ambient environmental temperature in which the treatment system 10a is installed is less than the lower critical solution temperature of the temperature-responsive polymer incorporated in the osmotic pressure inducer 12. In this case, at the point when treatment of the treatment target solution 14 using the treatment system 10a is started, the temperature-responsive polymer incorporated in the osmotic pressure inducer 12 has already undergone a phase change to a liquid state even without performing cooling with a cooling unit. Accordingly, when the osmotic pressure inducer 12 that has undergone a phase change to become solid in the separation unit 2 is not recycled, there is no need to cool the osmotic pressure inducer 12 using a cooling unit.

Further, even if the osmotic pressure inducer 12 supplied to the draw solution 13 in the osmotic pressure treatment unit 1 via the pipe 4a is at a temperature equal to or greater than the lower critical solution temperature, the osmotic pressure inducer 12 will be cooled gradually by the ambient environmental temperature and eventually reach a temperature less than the lower critical solution temperature, causing the temperature-responsive polymer incorporated in the osmotic pressure inducer 12 to undergo a phase change and become liquid. As a result, even if a cooling unit is not provided, the temperature-responsive polymer can still be subjected to a phase change to a liquid state, and the energy required for treating the treatment target solution 14 can be reduced.

### Second Embodiment

In the first embodiment, an example is described in which a material prepared by chemically modifying a support with a temperature-responsive polymer having a lower critical solution temperature is used as the osmotic pressure inducer 12. In a treatment system 20 of a second embodiment, a description is provided of the case in which a material prepared by chemically modifying a support with a temperature-responsive polymer having an upper critical solution temperature is used as an osmotic pressure inducer 22.

FIG. 3 is a schematic block diagram illustrating a treatment system of the second embodiment. The areas in which the treatment system 20 of the second embodiment illustrated in FIG. 3 differs from the treatment system 10 of the first embodiment illustrated in FIG. 1A are the type of temperature-responsive polymer incorporated in the osmotic pressure inducer 22, and the fact that the heating unit 3 and the cooling unit 31 are installed in the opposite locations. Descriptions of those members which are the same are omitted.

Examples of the temperature-responsive polymer having an upper critical solution temperature (UCST) incorporated in the osmotic pressure inducer 22 include acryloyl glycinamide, acryloyl nipectamide, acryloyl asparaginamide, acrylamide, acetyl acrylamide, biotinol acrylate, N-biotinyl-N′-methacryloyl trimethylene amide, acryloyl glycinamide, acryloyl sarcosinamide, methacryloyl sarcosinamide, acryloyl methyluracil, and N-acetylacrylamide-methacrylamide copolymers. The temperature-responsive polymer having an upper critical solution temperature (UCST) may be either a homopolymer or a copolymer.

The upper critical solution temperature of the temperature-responsive polymer is preferably at least 10° C. but not more than 50° C. It is preferable that the upper critical solution temperature satisfies the range, because it means that when the treatment system 20 of the present embodiment is installed and used under a room temperature environmental temperature of about 25° C., the energy required for the heating and/or cooling used to achieve phase change of the temperature-responsive polymer can be reduced. Furthermore, when the upper critical solution temperature satisfies the range, waste heat or the like from a factory or the like can be more easily used as the heat source for the heating unit 3, which is also desirable.

In the present embodiment, the heating unit 3 (temperature control unit) is used for heating the osmotic pressure inducer 22 within the draw solution 13 of the osmotic pressure treatment unit 1 to a temperature equal to or greater than the upper critical solution temperature, thereby causing a phase change to a liquid state for the temperature-responsive polymer incorporated in the osmotic pressure inducer 22.

Further, the cooling unit 31 (temperature control unit) is used for cooling the osmotic pressure inducer 22 within the draw solution 13 of the separation unit 2 to a temperature less than the upper critical solution temperature, thereby causing a phase change to a solid state for the temperature-responsive polymer incorporated in the osmotic pressure inducer 22.

The osmotic pressure inducer 22 can be produced in a similar manner to the osmotic pressure inducer 12 in the first embodiment.

Next, a treatment method for treating a treatment target solution using the treatment system 20 of the second embodiment illustrated in FIG. 3 is described.

First, the osmotic pressure inducer 22 is supplied to the transmission tank 1c inside the treatment tank 1a. The water that represents the solvent 15 for the treatment target solution 14 may also be supplied to the transmission tank 1c inside the treatment tank 1a in order to wet the contact region between the osmotic pressure inducer 22 and the semipermeable membrane 11 in advance, prior to the start of the treatment using the treatment system 20. The osmotic pressure inducer 22 supplied to the transmission tank 1c of the osmotic pressure treatment unit 1 is heated by the heating unit 3 so that the osmotic pressure inducer 22 within the draw solution 13 reaches a temperature equal to or greater than the upper critical solution temperature. As a result, the temperature-responsive polymer incorporated in the osmotic pressure inducer 22 is hydrated by the solvent and exists in a dissolved state.

In the present embodiment, the same types of methods as those used in the first embodiment described above for heating the osmotic pressure inducer 12 of the draw solution 13 held in the treatment tank 2a of the separation unit 2 can be used for heating the osmotic pressure inducer 22 within the draw solution 13 of the osmotic pressure treatment unit 1 to a temperature equal to or greater than the upper critical solution temperature.

Subsequently, as illustrated in FIG. 3, the salt water that represents the treatment target solution 14 is supplied to the supply tank 1b inside the treatment tank 1a of the osmotic pressure treatment unit 1, and then in the same manner as the first embodiment described above, a transmission treatment step is performed, and the draw solution 13 is supplied from the transmission tank 1c inside the treatment tank 1a of the osmotic pressure treatment unit 1 to the separation unit 2 via the pipe 5.

The temperature of the osmotic pressure inducer 22 within the draw solution 13 that has been transferred into the separation unit 2 is cooled by the cooling unit 31 to a temperature less than the upper critical solution temperature. As a result, the temperature-responsive polymer incorporated in the osmotic pressure inducer 22 undergoes a phase change and becomes solid.

Subsequently, in the same manner as the first embodiment described above, the separation membrane 21 of the separation unit 2 is used to separate the solvent 15 within the draw solution 13 from the draw solution 13 containing the osmotic pressure inducer 22 that has undergone a phase change to become solid. Then, the water (treated water) that represents the solvent 15 separated by the separation unit 2 is discharged via the treated liquid discharge unit 8.

Further, in the same manner as the first embodiment described above, the osmotic pressure inducer 22 that has undergone a phase change to become solid and has been separated in the separation unit 2 is supplied from the separation unit 2 to the draw solution 13 of the osmotic pressure treatment unit 1 via the pipe 4a (the recycling unit 4), and is reused.

The treatment system 20 of the present embodiment contains the osmotic pressure treatment unit 1 having the supply tank 1b which holds the treatment target solution 14, the transmission tank 1c which holds the draw solution 13, and the semipermeable membrane 11 which is interposed between the supply tank 1b and the transmission tank 1c, wherein the draw solution 13 contains the osmotic pressure inducer 22 prepared by chemically modifying the support with the temperature-responsive polymer having a higher critical solution temperature, and the solvent 15. As a result, in a similar manner to the treatment system 10 of the first embodiment, no energy is required to cause the treatment target solution 14 to permeate through the semipermeable membrane 1, and the energy required for treating the treatment target solution 14 can be reduced.

Furthermore, in the treatment system 20 of the present embodiment, the draw solution 13 contains the osmotic pressure inducer 22 prepared by chemically modifying the support with the temperature-responsive polymer having a higher critical solution temperature, and the solvent 15. By ensuring that the temperature of the osmotic pressure inducer 22 prepared by chemically modifying the support with the temperature-responsive polymer having a higher critical solution temperature is less than the higher critical solution temperature, the temperature-responsive polymer incorporated in the osmotic pressure inducer 22 undergoes a phase change and becomes solid. The solid osmotic pressure inducer 22 has extremely low solubility and exhibits excellent shape stability, and therefore the filtration rate is fast and the handling properties are favorable. Accordingly, the solid osmotic pressure inducer 22 can be readily separated from the draw solution 13 with good precision.

As a result, compared with the case where, for example, only a temperature-responsive polymer having a higher critical solution temperature is used instead of the osmotic pressure inducer 22, impurities incorporated as a result of treating the treatment target solution 14 are less likely to be retained in the treated liquid (the treated water), meaning a high-purity treated water can be obtained.

Next is a description of other examples of the treatment system of the embodiments of the present invention.

In each of the embodiments descried above, the case in which water is extracted from salt water is described as an example of the treatment system, but the treatment systems are not limited to the extraction of water from salt water. In other words, the treatment target solution that is treated by the treatment system may be any solution that can be treated by an osmotic pressure treatment using an osmotic pressure inducer and a semipermeable membrane, and other examples include ground water and industrial waste water and the like.

In each of the embodiments described above, the case is described in which the temperature control unit included a heating unit, but the temperature control unit may have only a cooling unit for cooling the osmotic pressure inducer. The temperature control unit is a device that can cause a phase change of the osmotic pressure inducer by heating or cooling the osmotic pressure inducer within the draw solution in the osmotic pressure treatment unit and/or the separation unit, and the decision as to whether both a heating unit and a cooling unit, only a heating unit, or only a cooling unit is selected can be determined appropriately in accordance with the type of temperature-responsive polymer incorporated in the osmotic pressure inducer and the ambient environmental temperature in which the treatment system is installed.

According to at least one of the embodiments described above, by including an osmotic pressure treatment unit having a first tank which holds a treatment target solution, a second tank which holds a draw solution, and a semipermeable membrane which is interposed between the first tank and the second tank, and using a draw solution containing an osmotic pressure inducer, prepared by chemically modifying a support with a polymer having an upper critical solution temperature or a lower critical solution temperature, and a solvent, the energy required for treating the treatment target solution can be reduced, and impurities incorporated as a result of the treatment are unlikely to remain in the treated liquid (treated water), meaning a high-purity treated water can be obtained.

### EXAMPLES

The osmotic pressure inducers described below are synthesized and evaluated.

### Example 1

The silane coupling agent, i.e. 5 g of 3-mercaptopropyltrimethoxysilane, and 20 mL of acetone are added to 7 g of a silica gel. The solvent is evaporated using an evaporator, and the product is dried at 90° C. for 24 hours.

Next, 0.5 g of the obtained solid, 1 g of N-isopropyl acrylamide (LCST=32° C.), and 0.3 g of the radical initiator azobisisobutyronitrile (AIBN) are added to 15 mL of anisole, and the mixture is reacted under a nitrogen atmosphere at 75° C. for 24 hours. The obtained solid is filtered, washed with acetone, and then dried under reduced pressure, yielding an osmotic pressure inducer composed of a white solid.

### Example 2

With the exception of using magnetite instead of the silica gel, an osmotic pressure inducer composed of a brown solid is obtained in the same manner as Example 1.

### Example 3

To 50 mL of pure water, 5 g of a silica gel, 9 g of iron (11) chloride tetrahydrate and 24 g of iron (III) chloride hexahydrate are added, and following stirring at 75° C., 100 mL of a 28% aqueous solution of ammonia is added dropwise, and the resulting mixture is reacted for 30 minutes. Following the reaction, the mixture is filtered, and the solid is washed thoroughly with pure water and dried. As a result, a magnetite-silica support composed of a reddish brown solid is obtained in which base particles formed from silica had been coated with a coating layer composed of magnetite. Then, with the exception of using the obtained magnetite-silica support instead of the silica gel, an osmotic pressure inducer composed of a reddish brown solid is obtained in the same manner as Example 1.

### Comparative Example 1

An osmotic pressure inducer is prepared by dissolving 0.1 g of poly-N-isopropyl acrylamide in 2 mL of pure water.

Each of the osmotic pressure inducers of Examples 1 to 3 and Comparative Example 1 obtained in the manner described above are evaluated by performing the tests described below.

### (Test 1: Measurement of Osmotic Pressure)

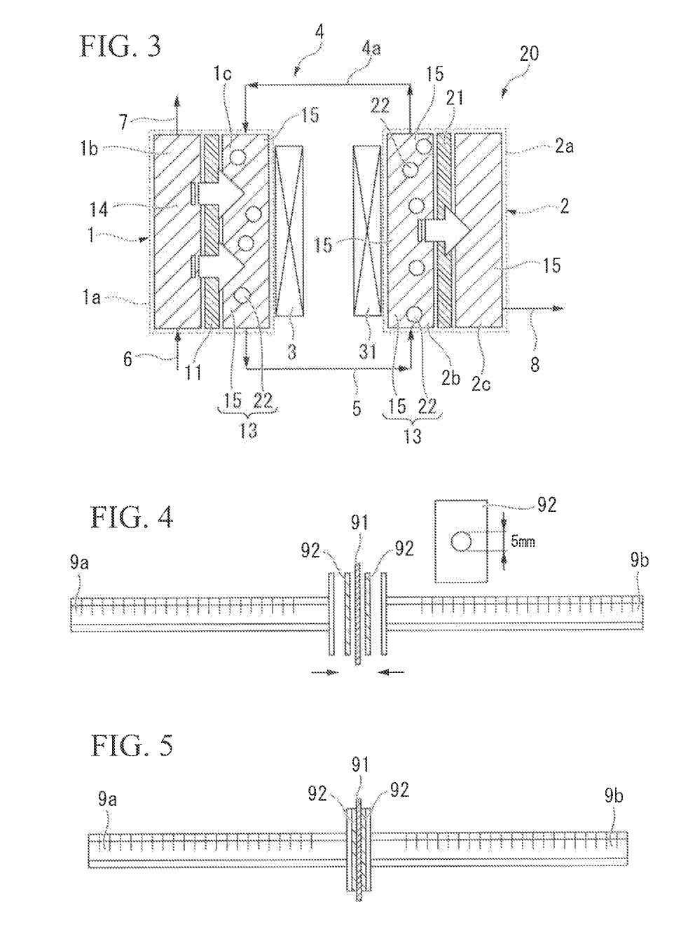

A semipermeable membrane 91 (product name: ES-20, manufactured by Nitto Denko Corporation), and rubber packers 92, each having a circular hole with a diameter of 5 mm in the center, disposed on either side of the semipermeable membrane 91 are sandwiched between two circular cylinders having an inner diameter of 5 mm, namely a first circular cylinder 9a and a second circular cylinder 9b illustrated in FIG. 4, and the resulting structure is secured as illustrated in FIG. 5. A plan view of the packers 92 is also illustrated in FIG. 4.

Then, a 0.01 wt % aqueous solution of sodium chloride which represents the treatment target solution is placed in the first circular cylinder 9a. Further, 0.1 g of the osmotic pressure inducer is placed in the second circular cylinder 9b. In order to wet the region where the osmotic pressure inducer contacts the membrane, 1 mL of water is also inserted into the second circular cylinder 9b.

In the sample prepared in this manner, when the solvent within the treatment target solution permeates through the semipermeable membrane due to the difference in osmotic pressure, the amount of water in the first circular cylinder 9a reduces, and the amount of water in the second circular cylinder 9b increases. The presence or absence of movement of the water through the semipermeable membrane is adjudged on the basis of the change in the amount of water in the first circular cylinder 9a alter 24 hours. The test temperature for this test 1 is 25° C.

### (Test 2: Recycling Test by Heating/Cooling)

Each of the samples of Examples 1 to 3 and Comparative Example 1 that had been subjected to Test 1 is heated to 40° C., the amount of water in the second circular cylinder 9b is reduced to the amount of water prior to Test 1, and the temperature is then cooled to room temperature. Subsequently. Test 1 is then repeated in the same manner as described above.

### (Test 3: Recycling Test by Magnetic Field Application)

An alternating magnetic field is applied to the sample that had been subjected to Test 1 using the conditions described below, and the amount of water in the second circular cylinder 9b is reduced to the amount of water prior to Test 1. Subsequently, Test 1 is then repeated in the same manner as described above.

A Function Generator 3310B (manufactured by Yokogawa Hewlett Packard Co., Ltd.) is connected to the tip of an Amp 4005 High Speed Power Amplifier (manufactured by NF Electronic Instruments Co., Ltd.), a copper coil (614 T) is electrified under conditions of 150 mVp-p and 75 mAp-p at 300 Hz, and with the sample placed inside the coil, a magnetomotive force of 1535 AT/m is generated and held for 1 hour.

### (Test 4: Measurement of Filtration Rate)

The pure water 10 mL is added to a 0.5 g sample of the osmotic pressure inducer of each of Examples 1 to 3, and with the temperature held at 40° C., a suction filtration is performed using a Kiriyama funnel (filter paper: 5c), and the time taken to complete the filtration is measured.

In the case of Comparative Example 1, 0.5 g of the poly-N-isopropyl acrylamide is used as the osmotic pressure inducer.

### (Test 5: Polymer Elution Test)

The presence or absence of organic components (TOC) within the water collected from the second circular cylinder 9b in Test 2 is measured using a total organic carbon meter. The presence or absence of elution of the polymer into the water is determined on the basis of this measurement.

The results of each of the tests for Examples 1 to 3 and Comparative Example 1 are shown in Table 1.

The results for Test 2 and Test 3 are recorded by specifying the transmission rate observed in Test 1 as a standard (1.0), and then determining whether or not there is any change relative to that standard.

Further, in Examples 1 to 3 and Comparative Example 1, a pocket salt meter PAL-ES2 (product name, manufactured by Atago Co., Ltd.) is used to determine the salt concentration of the water that had passed through the membrane. In each of Examples 1 to 3 and Comparative Example 1, the result is less than the detection limit.

TABLE 1

| | | Test 2 | Test 3 | | | |
|---|---|---|---|---|---|---|
| | | Water | Water | | | |
| | Test 1 | transmission | transmission | | | Test 5 |
| | Water | rate | rate | Test 4 | | Poly- |
| | trans- | relative to | relative to | Filtration | | mer |
| Sample | mission | Test 1 | Test 1 | rate | | elution |
| Example 1 | yes | 1.0 | — | 7 | seconds | no |
| | | | | | | elution |
| Example 2 | yes | 1.0 | 1.0 | 10 | seconds | no |
| | | | | | | elution |
| Example 3 | yes | 1.0 | 1.0 | 9 | seconds | no |
| | | | | | | elution |
| Example 4 | yes | 1.0 | — | 7 | seconds | no |
| | | | | | | elution |
| Comparative | yes | 0.8 | — | 12 | minutes | elution |

| | |
|---|---|
| Example 1 | yes |

### Example 4

The silane coupling agent. i.e. 5 g of 3-mercaptopropyltrimethoxysilane, and 20 mL of acetone are added to 7 g of a silica gel. The solvent is evaporated using an evaporator, and the product is dried at 90° C. for 24 hours.

Subsequently, 0.5 g of the obtained solid, 1.36 g of N-acetyl acrylamide, 0.085 g of methacrylamide, and 0.3 g of the radical initiator azobisisobutyronitrile (AIBN) are added to 15 mL of anisole, and the mixture is reacted under a nitrogen atmosphere at 75° C. for 24 hours. The obtained modified solid of an N-acetyl acrylamide-methacrylamide copolymer (UCST=21° C.) is filtered, washed with acetone, and then dried under reduced pressure, yielding an osmotic pressure inducer composed of a reddish brown solid.

The osmotic pressure inducer of Example 4 obtained in the manner described above is evaluated by performing the tests described below.

### (Test 1: Measurement of Osmotic Pressure)

The test is performed in the same manner as described above for Example 1.

### (Test 2: Recycling Test by Heating/Cooling)

The sample of Example 4 that had been subjected to Test 1 is cooled to 4° C., the amount of water in the second circular cylinder 9b is reduced to the amount of water prior to Test 1, and the temperature is then returned to room temperature. Subsequently, Test 1 is then repeated in the same manner as described above.

### (Test 4: Measurement of Filtration Rate)

The pure water 10 mL is added to a 0.5 g sample of the osmotic pressure inducer of Example 4, and with the temperature held at 4° C. a suction filtration is performed using a Kiriyama funnel (filter paper: 5c), and the time taken to complete the filtration is measured.

### (Test 5: Polymer Elution Test)

The test is performed in the same manner as described above for Example 1.

The result of each test for Example 4 is shown in Table 1.

The result for Test 2 is recorded by specifying the transmission rate observed in Test 1 as a standard (1.0), and then determining whether or not there is any change relative to that standard.

Further, in Example 4, a pocket salt meter PAL-ES2 (product name, manufactured by Atago Co., Ltd.) is used to determine the salt concentration of the water that had passed through the membrane. The result is less than the detection limit.

As illustrated in Table 1, by using the osmotic pressure inducers of Examples 1 to 4, the solvent within the treatment target solution is able to be passed through the semipermeable membrane. Further, it is found that by heating the osmotic pressure inducers of Examples 1 to 3 to a temperature equal to or greater than the lower critical solution temperature, or by cooling the osmotic pressure inducer of Example 4 to a temperature equal to or less than the upper critical solution temperature, the osmotic pressure-inducing function of each osmotic pressure inducer could be reclaimed.

Further, based on the results of Test 3 for Example 2 and Example 3, in which the support is a magnetic body, it is found that by using a method in which an alternating magnetic field is applied, the osmotic pressure-inducing function of the osmotic pressure inducer could be reclaimed.

In Comparative Example 1, the solvent within the treatment target solution is able to be passed through the semipermeable membrane using the difference in osmotic pressure. However, as is evident from the result of Test 2 for Comparative Example 1, the transmission rate decreased following heating to a temperature equal to or greater than the lower critical solution temperature.

It is thought that the reason for this observation is that when the polymer used in Comparative Example 1 is in a heated state at a temperature equal to or greater than the lower critical solution temperature, the material includes polymers having a small molecular weight which exhibit inadequate insolubility. Further, it is also assumed that when the polymer is in a heated state at a temperature equal to or greater than the lower critical solution temperature, some polymers exist in a dissolved state in the water. It is thought that because the polymer used in Comparative Example 1 is not fixed to the surface of a solid, those polymers that exist in a dissolved state in the water when the polymer is in a heated state at a temperature equal to or greater than the lower critical solution temperature are removed together with the transmitted water. It is surmised that, as a result, the total amount of the osmotic pressure inducer decreases, and the transmission rate following heating to a temperature equal to or greater than the lower critical solution temperature also decreases.

Further, in Comparative Example 1, elution of the polymer into the water occurred.

Furthermore, in Comparative Example 1, the filtration rate is extremely slow, and the handling properties are poor.

Based on the results described above, it is evident that the osmotic pressure inducers and the treatment methods used in the examples yielded favorable handling properties, and enabled the osmotic pressure-inducing force to be maintained even following recycling.

While certain embodiments have been described, these embodiments have been presented by way of example only, and are note intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A treatment system, comprising an osmotic pressure treatment unit having:
a first tank which holds a treatment target solution,
a second tank which holds a draw solution containing an osmotic pressure inducer and a solvent, and
a semipermeable membrane which is interposed between the first tank and the second tank, wherein
the osmotic pressure inducer is prepared by chemically modifying a support with a polymer having an upper critical solution temperature or a lower critical solution temperature.

2. The treatment system according to claim 1, further comprising a separation unit having:
a third tank which holds the draw solution containing the osmotic pressure inducer,
a fourth tank which holds the solvent which has been separated from the draw solution, and
a separation membrane which is interposed between the third tank and the fourth tank, and has pores having the smaller size than the osmotic pressure inducer that has undergone a phase change to become solid, wherein
the osmotic pressure treatment unit and/or the separation unit has a temperature control unit which heats or cools the osmotic pressure inducer within the draw solution.

3. The treatment system according to claim 1, wherein
the osmotic pressure inducer is prepared by chemically modifying a support with a polymer having a lower critical solution temperature, and
the separation unit has a heating unit which heats the osmotic pressure inducer within the draw solution of the separation unit.

4. The treatment system according to claim 1, wherein
the osmotic pressure inducer is prepared by chemically modifying a support with a polymer having an upper critical solution temperature, and
the osmotic pressure treatment unit has a heating unit which heats the osmotic pressure inducer within the draw solution of the osmotic pressure treatment unit.

5. The treatment system according to claim 1, wherein the support comprises a magnetic body.

6. The treatment system according to claim 3, wherein the support comprises a magnetic body, and the heating unit applies an alternating magnetic field to the support.

7. The treatment system according to claim 4, wherein the support comprises a magnetic body, and the heating unit applies an alternating magnetic field to the support.

8. The treatment system according to claim 5, wherein the magnetic body is composed of particles comprising one or more of iron, cobalt and nickel.

9. The treatment system according to claim 2, further comprising a recycling unit having a pipe which connects the third tank and the second tank.

10. A treatment method, which uses the treatment system according to claim 1 to treat a treatment target solution, the method comprising:
a transmission treatment step of supplying the treatment target solution to the first tank of the osmotic pressure treatment unit, and passing a solvent within the treatment target solution through the semipermeable membrane using a difference in osmotic pressure between the treatment target solution and the draw solution, thereby moving the solvent into the second tank.
